(19) United States
(12) Patent Application Publication
(10) Pub. No.: US 2025/0372072 A1
(43) Pub. Date: Dec. 4, 2025

(54) Sound Damping Device

(71) Applicants: Elisabeth Sitter, Grünburg (AT); Michael Dominik, Bichl (DE)

(72) Inventor: Dominik Sitter, Bichl (DE)

(21) Appl. No.: 18/862,805

(22) PCT Filed: Mar. 22, 2023
(86) PCT No.: PCT/DE2023/100222

§ 371 Date: Aug. 13, 2025

(30) Foreign Application Priority Data
May 4, 2022 (DE) 10 2022 110 970.4

(51) Int. Cl. G10K 11/172; G10K 11/165

(52) U.S. Cl. CPC G10K 11/172; G10K 11/165

(57) ABSTRACT

In a sound damping device having an absorption body with an inlet opening for the entry of sound waves to be attenuated, and an opposite outlet opening, effective sound absorption over a broad frequency spectrum is achieved in that the absorption body has a first end close to the inlet opening and a second end opposite the first end and close to the outlet opening. The two ends are connected to one another by a central axis. Laterally of the central axis between the first end and the other end, one or more sound-guiding walls are formed which, starting near the central axis at the inlet opening, increase in width outward toward the second end and terminate, in the region of the second end, at a terminal edge whose starting point adjoins the central axis and whose end point is arranged at a predetermined distance from the central axis.

The invention relates to a sound damping device comprising an absorption body with an inlet opening for the entry of sound waves to be attenuated and an outlet opening located opposite the inlet opening for the discharge of sound waves.

Sound damping devices of the type mentioned at the outset—often also without an outlet opening—are known in the prior art in a wide variety of different embodiments and are used for very different specific purposes. However, the known sound damping devices have the disadvantage that high efficiency of sound absorption can be achieved only with considerable technical effort and thus considerable cost.

Object of the invention is therefore to provide a sound-damping device in which effective sound absorption can be achieved cost-effectively over a broad frequency spectrum with comparatively simple means.

For a sound-damping device of the type mentioned at the outset, this object is achieved according to the invention in that the absorption body has a first end close to the inlet opening and a second end, opposite the first end, close to the outlet opening, which are connected to one another via a central axis, wherein, laterally of the central axis between the first end and the other end, one or more sound-guiding walls are formed which, starting near the central axis at the inlet opening, increase in width outward toward the second end and, in the region of the second end, end at a terminal edge whose starting point adjoins the central axis and whose end point is arranged at a predetermined distance from the central axis.

Preferred embodiments of the invention are the subject of the dependent claims, the elements of which act to further improve the solution approach underlying the object of the invention.

In the sound-damping device according to the invention, by means of the combination of features that the absorption body has a first end close to the inlet opening and a second end, opposite the first end, close to the outlet opening, which are connected to one another via a central axis, wherein, laterally of the central axis between the first end and the other end, one or more sound-guiding walls are formed which, starting near the central axis at the inlet opening, increase in width outward toward the second end and, in the region of the second end, end at a terminal edge whose starting point adjoins the central axis and whose end point is arranged at a predetermined distance from the central axis, it is achieved that, with the aid of the sound-guiding walls of varying width, resonant bodies for different frequencies are created, wherein, in particular, when the outlet opening is positioned in front of a sound-reflective wall, a desired cancellation of sound takes place within a sound-guiding wall.

According to a first preferred embodiment of the sound-damping device according to the invention, it is provided that the width of a given sound-guiding wall increases linearly from the inlet opening located near the central axis toward the other end, the first end of the absorption body being opposite the end point of the terminal edge remote from the central axis via a straight connecting line, and a respective outer edge of a sound-guiding wall lying on the connecting line.

According to an alternative preferred embodiment of the sound-damping device according to the invention, the width of the sound-guiding walls increases non-linearly starting from the inlet opening located near the central axis toward the other end, the first end of the absorption body being opposite the end point of the terminal edge remote from the central axis by way of a concavely curved connecting line, and a respective outer edge of a sound-guiding wall lying on the connecting line.

A sound-guiding wall is preferably formed as a hollow rail that is open toward the first end of the absorption body.

In certain applications it may also be advisable for a sound-guiding wall to be configured as a rail that is at least partially concavely shaped toward the second end of the absorption body.

According to an important preferred embodiment of the sound-damping device according to the invention, a sound-guiding wall is configured as a rail that is at least partially convexly shaped toward the second end of the absorption body. An outer edge of a sound-guiding wall may in this case be formed with a stronger bend toward the first end of the absorption body than the inner wall opposite the outer edge.

The terminal edge of a sound-guiding wall is preferably oriented perpendicular to the central axis. However, in alternative embodiments the terminal edge may be oriented at a predetermined angle to the central axis, wherein the end point of the terminal edge projects beyond the starting point by way of an extended outer edge.

According to a further preferred embodiment of the sound-damping device according to the invention, in the region of the surface of a sound-guiding wall one or more sound-diffusion elements are arranged, the starting point of each adjoins the central axis and the end point of each lies at the outer edge of the respective sound-guiding wall.

According to another important preferred embodiment of the sound-damping device according to the invention, in the region of the terminal edge of a sound-guiding wall there is arranged a sound-reflection element oriented at right angles to the surface of the sound-guiding wall, the starting point of which adjoins the central axis and the end point of which lies at the outer edge of the respective sound-guiding wall.

In the case of two sound-guiding walls, the absorption body is preferably configured to be rotationally symmetric with respect to a rotation of 180° about the central axis; in the case of three sound-guiding walls, it is rotationally symmetric with respect to a rotation of 120° about the central axis; and in the case of four sound-guiding walls, it is rotationally symmetric with respect to a rotation of 90° about the central axis.

Furthermore, the absorption body is preferably manufactured from a dimensionally stable, hard material, such as acrylonitrile-butadiene-styrene copolymer (ABS) or PLA (a polylactide).

The absorption body may also be made of a metal such as stainless steel or aluminum, or of concrete.

For the manufacturing process of the absorption body, fused deposition modeling (FDM) is particularly envisaged.

The absorption body according to the invention preferably has, from the first end to the other end, a height in the range of 5 cm to 50 cm, and in particular of about 30 cm, while the terminal edge of a sound-guiding structure preferably has a width in the range of 2 cm to 40 cm, and in particular of about 20 cm.

One or more absorption bodies may preferably be positioned in front of a sound-reflection wall, the central axis of each absorption body being arranged perpendicular to the surface of the sound-reflection wall and the respective outlet opening of the absorption body being arranged opposite the sound-reflection wall.

The sound-damping device according to the invention will be explained below with reference to a preferred embodiment shown in the drawing figure. In this regard, the figures show:

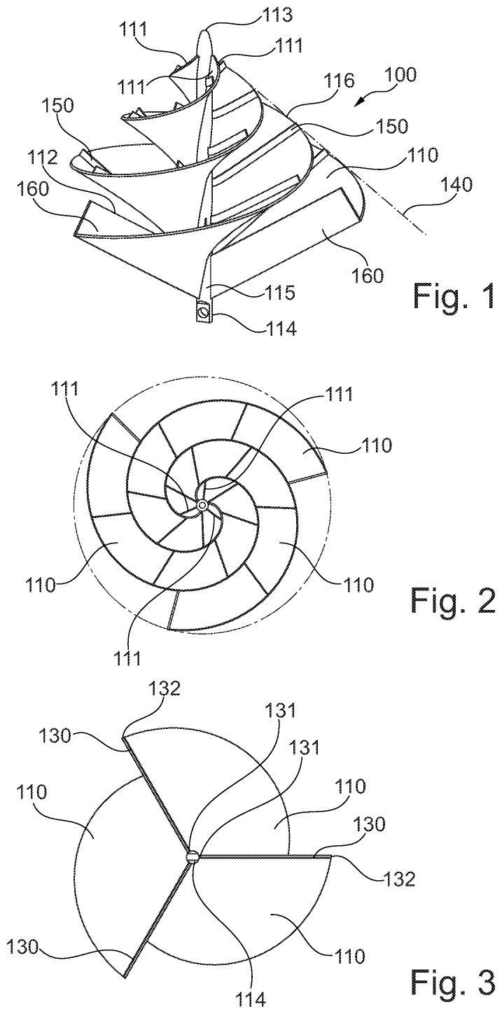

FIG. 1 a preferred embodiment of the sound-damping device according to the invention in a side view; the

FIG. 2 preferred embodiment of the sound-damping device according to the invention, shown in FIG. 1, in a side view from above;

FIG. 3 preferred embodiment of the sound-damping device according to the invention, shown in FIG. 1, in a side view from below.

The sound-damping device 100 according to the invention shown in FIGS. 1 to 3 comprises an absorption body 110 with an inlet opening 111 for the entry of sound waves to be attenuated and an outlet opening 112 opposite the inlet opening 111, the absorption body 110 having a first end 113 near the inlet opening 111 and a second end 114 opposite the first end 113 and near the outlet opening 112, which are connected to one another by a central axis 115. Laterally of the central axis 115, between the first end 113 and the second end 114, one or more sound-guiding walls 120 are formed.

The sound-guiding walls 120 begin near the central axis at the inlet opening 111, increase in width outwardly toward the second end 114, and terminate in the region of the second end 114 at a terminal edge 130, whose start point 131 adjoins the central axis 115 and whose end point 132 is arranged at a predetermined distance from the central axis 115.

The width of the respective sound-guiding wall 120 increases, starting from the inlet opening 111 close to the central axis, linearly toward the other end 114, the first end 113 of the absorption body 110 thereby facing, via a straight connecting line 140, the end point 132 of the terminal edge 130 that is remote from the central axis 115, and the respective outer edge of a sound-guiding wall 120 lies on the connecting line 140.

A sound-guiding wall 120 is formed as a hollow rail open toward the first end 113 of the absorption body 110, which, toward the second end 114 of the absorption body 110, is formed at least partially with a convex shape.

In this context, an outer edge of a sound-guiding wall 120 is configured to be bent more strongly toward the first end of the absorption body 110 than the inner wall opposite the outer edge. The terminal edge 130 of a sound-guiding wall 120 is oriented perpendicular to the central axis 115.

According to the embodiment of the sound-damping device 100 shown in FIG. 2, one or more sound-diffusion elements 150 are arranged in the region of the surface of a sound-guiding wall 120, each having a start point adjoining the central axis 115 and an end point 132 located at the outer edge of the respective sound-guiding wall 120.

According to the preferred embodiment of the inventive sound-damping device 100 shown in FIG. 2, a sound-reflection element 160 that is oriented at a right angle to the surface of the sound-guiding wall 120 is arranged in the region of the terminal edge 130 of a sound-guiding wall 120, the start point 131 of the sound-reflection element adjoining the central axis 115 and its end point 132 being located at the outer edge of the respective sound-guiding wall 120.

The illustrated absorption body 110 is provided with three sound-guiding walls 120 and is formed to be rotationally symmetric with respect to a rotation of 120° about the central axis 115.

The absorption body 110 is made of a dimensionally stable, hard material, in the present case ABS (acrylonitrile-butadiene-styrene copolymer).

The absorption body 110 has a height of about 30 cm from the first end 113 to the other end 114, the terminal edge 130 of a sound-guiding structure having a width of 20 cm.

According to the invention, one or more of the illustrated absorption bodies 110 are placed in front of a sound-reflective wall 200, the central axis 115 of each absorption body 110 being arranged at a right angle to the surface of the sound-reflective wall 200 and a corresponding outlet opening 112 of the absorption body 110 being arranged opposite the sound-reflective wall 200.

The exemplary embodiment of the invention explained above serves solely to facilitate a better understanding of the teaching according to the claims and, as such, is not limited by the exemplary embodiment.

### REFERENCE NUMERALS LIST

100 Sound-damping device
110 Absorption body
111 Inlet opening
112 Outlet opening
113 First end
114 Other end
115 Central axis
116 Outer edge
120 Sound-guiding walls
130 Terminal edge
131 Starting point
132 End point
140 Straight connecting line
150 Sound-diffusion element
160 Sound-reflection element
200 Sound-reflective wall

1.-10. (canceled)

11. A sound-damping device comprising:
an absorption body with an inlet opening for the entry of sound waves to be attenuated and an outlet opening opposite the inlet opening, the absorption body having a first end close to the inlet opening and another end, opposite the first end, close to the outlet opening, which are connected to one another by a central axis, wherein:
laterally of the central axis between the first end and the other end, one or more sound-guiding walls are formed which, starting near the central axis at the inlet opening increase in width outward toward the other end and terminate, in the region of the other end, at a terminal edge whose starting point adjoins the central axis and whose end point is arranged at a predetermined distance from the central axis; and
one or more sound-diffusion elements are arranged in the region of the surface of a sound-guiding wall, each having a starting point adjoining the central axis and an end point lying at the outer edge of the respective sound-guiding wall.

12. The sound-damping device according to claim 11, wherein:
the width of a respective sound-guiding wall increases linearly from the inlet opening close to the central axis toward the other end, the first end of the absorption body thereby facing, via a straight connecting line, the end point of the terminal edge that is remote from the central axis, and
a respective outer edge of a sound-guiding wall lies on the connecting line.

13. The sound-damping device according to claim 11, wherein the width of the sound-guiding walls increases non-linearly from the inlet opening close to the central axis toward the other end, the first end of the absorption body thereby facing, via a concavely curved connecting line, the end point of the terminal edge that is remote from the central axis, and a respective outer edge of a sound-guiding wall lies on the connecting line.

14. The sound-damping device according to claim 11, wherein a sound-guiding wall is formed as a hollow rail open toward the first end of the absorption body.

15. The sound-damping device according claim 14, wherein an outer edge of a sound-guiding wall is formed to be bent more strongly toward the first end of the absorption body than the inner wall lying opposite the outer edge.

16. The sound-damping device according to claim 11, wherein a sound-guiding wall is formed as a rail that is at least partially convexly shaped in the direction of the second end of the absorption body.

17. The sound-damping device according claim 16, wherein an outer edge of a sound-guiding wall is formed to be bent more strongly toward the first end of the absorption body than the inner wall lying opposite the outer edge.

18. The sound-damping device according to claim 11, wherein a sound-guiding wall is formed as a rail that is at least partially concavely shaped in the direction of the second end of the absorption body.

19. The sound-damping device according claim 18 wherein an outer edge of a sound-guiding wall is formed to be bent more strongly toward the first end of the absorption body than the inner wall lying opposite the outer edge.

20. The sound-damping device according to claim 11, wherein the terminal edge is aligned perpendicular to the central axis.

21. The sound-damping device according to claim 11, wherein the terminal edge is aligned at a predetermined angle relative to the central axis, the end point of the terminal edge projecting, by way of a prolongation of the outer edge, beyond the start point of the terminal edge.
